(19) United States
(12) Patent Application Publication
(10) Pub. No.: US 2007/0046484 A1
(43) Pub. Date: Mar. 1, 2007

(54) ELECTRONIC PARKING IDENTIFICATION AND SURVEILLANCE SYSTEM AND METHOD

(76) Inventors: Andrew Bucholz, Alexandria, VA (US); Patrick Minix, Falls Church, VA (US)

Correspondence Address: 24IP LAW GROUP USA, PLLC, 12 E. LAKE DRIVE, ANNAPOLIS, MD, 21403, US

(21) Appl. No.: 11/466,005

(22) Filed: Aug. 21, 2006

Related U.S. Application Data
(60) Provisional application No. 60/709,903, filed on Aug. 22, 2005.

(51) Int. Cl. G08B 21/00; G08G 1/14

(52) U.S. Cl. 340/686.1; 340/932.2

(57) ABSTRACT

The on-street parking and surveillance system uses a combination of machine readable tags mounted on the parking spots to identify specific parking regulations to a survey vehicle for enforcement using license plate reading devices. The combination of machine readable tags with encoded parking rules on the controlled parking property eliminates the errors associated with GPS based systems and allows a wide of parking regulations to be enforced. The incorporation of a device to read markers, tags, and devices other then license plates allows the system to monitor modem parking payment systems; such as kiosks and internet based payment schemes, and manage increasingly complex local parking regulations and exemptions.

### CROSS-REFERENCE TO RELATED APPLICATIONS

The present application claims the benefit of U.S. Provisional Application Ser. No. 60/709,903 entitled “Electronic Parking Identification and Surveillance System and Method” and filed on Aug. 19, 2005.

### STATEMENT REGARDING FEDERALLY SPONSORED RESEARCH OR DEVELOPMENT

None.

### BACKGROUND OF THE INVENTION

1. Field Of The Invention

The present invention relates to the identification and enforcement of a wide variety of on-street and off-street parking regulations.

2. Brief Description Of The Related Art

License plate reading is used for a variety of parking enforcement tasks; in fixed positions monitoring entry and egress from parking facilities, and in mobile applications; particularly the identification of vehicles that are wanted for outstanding fines (scofflaws) and for those that have stayed in one parking spot too long. Additionally, systems to assist in the writing of tickets by reading a license plate and filling in fields are beginning to be marketed. The use of machine-readable optical or radio frequency markers is used for entry and egress applications and toll collection systems. Other approaches to management of parking regulations include the emplacement of sensors or fixed cameras that monitor vehicle presence.

An example of a prior parking regulation system is described in U.S. Pat. No. RE38,626 in which a video camera is mounted on a parking enforcement patrol vehicle and connected to a computer near the operator. The system is driven along a patrol route where parked vehicles are governed by a posted time limit. The system enforces the local parking regulation by automatically determining whether or not each parked car has been parked longer than the posted time limit. Violations are detected by applying a License Plate Recognition algorithm to the images. Each license plate number is time-tagged, geo-referenced and entered into a local database. When the patrol vehicle re-traces the patrol route after the posted parking time limit has expired, the database is searched to flag vehicles that were observed at the same location during the previous circuit and therefore in violation of the parking regulations. When the system detects a parking violation, it prints a parking citation that the operator affixes to the offending parked vehicle. The patent further discloses system for locating lost vehicles in which license plates are scanned for all cars parked in a particular lot and are cross-referenced with a location determined via a global positioning system. If customers cannot recall the locations of their vehicles, a search can be performed of the database to determine the location of a particular vehicle in the parking lot.

### SUMMARY OF THE INVENTION

The present invention combines the use of mobile license plate reading and markers to identify parking spots and regulations. The enforcement of on-street parking regulations is complicated by the number of overlapping regulations that can apply to any one block or parking spot, the exemptions granted to residents and other vehicles, and the intermixing of parking meters and regulated parking. The present invention envisions the use of specific machine-readable markers; analogous to the parking sign, to identify the parking regulations in effect for a given spot or block of spots. The markers contain coded information such as time and date restrictions, allowed exemptions, and other regulations. This coded information is used in conjunction with license plate reading cameras and other machine-readable tags to enforce parking rules.

Additionally the enforcement of off-street parking (e.g. an airport parking garage) is inefficient due to the number of employees that currently must drive past and manually record the license plate number and parking space number for every vehicle and parking space on the premises. Similar means used for the identification of on-street vehicles and regulations may be used for off-street parking enforcement.

The invention allows parking managers to survey and enforce parking regulations in an effective and cost efficient manner. The variety of parking rules in effect in an urban environment is a significant barrier to the effective enforcement of parking regulations; this invention allows the automated system to interpret the displayed regulations and enforce the specific rules for the specific block of vehicles or parking spots, not use general rules or rely on inaccurate positioning systems. Other inventions utilizing positioning systems have not proven to be cost effective or feasible given the current state of technology. Particularly, the error rate of positioning systems in urban areas is not sufficient to reliably locate a specific parking spot or identify the specific rules in place for a given parking spot. The present invention addresses the several legal and liability concerns for the parking system managers; the uncertainty associated with systems that utilize positioning systems allows legal challenges to ticket validity and this invention provides for efficient survey operations without incurring the safety liabilities associated with traditional methods of tire chalking.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRITION OF THE DRAWINGS

For a more complete understanding of the present invention and the advantages thereof, reference is now made to the following description and the accompanying drawings, in which:

FIG. 1 is a diagram of a system of a preferred embodiment of the present invention.

FIG. 2 is a diagram of a system of a preferred embodiment of the present invention.

FIG. 3 is a diagram of a method of a preferred embodiment of the present invention.

FIG. 4 is a diagram of a system of a preferred embodiment of the present invention.

FIG. 5 is a diagram of a system of a preferred embodiment of the present invention.

### DETAILED DESCRIPTION OF THE PREFERRED EMBODIMENTS

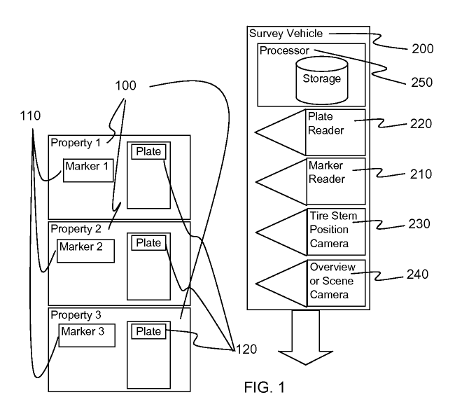

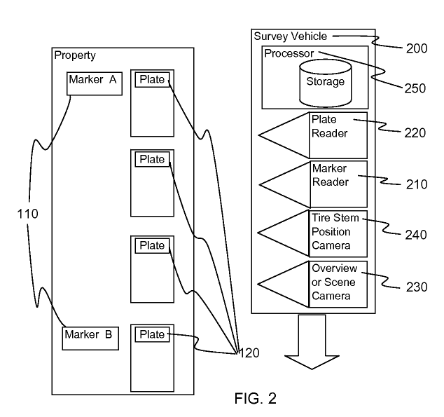

A preferred embodiment of the present invention of a method and apparatus for parking enforcement using machine readable markers 110 emplaced on parking spots 100 or at the beginning and end of a series of parking spots is shown in FIG. 1. The markers 110 have the specific parking regulations encoded on or within them. The specific regulations can be a diverse set of time and date restrictions; such as: one hour parking between eight AM and noon, no parking from eight PM to eight AM—except for district three permit holders, and no parking between noon and two on Thursdays for street cleaning, etc. As shown in FIGS. 1 and 2, the parking manager utilizes a survey vehicle 200 outfitted with, for example, a device 210 to read the markers 110, license plate reading devices 220 (e.g. a video camera), a camera to monitor tire stem position 230, an overview or scene camera 240 and a processor 250 with a display (not shown) and storage 252. The survey vehicle 200 approaches a parking spot or series of spots 100, and uses the marker-reading device 210 to determine what regulations are in effect. The survey vehicle 200 then records from the parked vehicle(s) a license plate number from license plate(s) 120, a response from a machine-readable marker 110, an overview or scene image, and an image of the vehicle tire position. The processor 250 on the survey vehicle 200 analyzes the collected information; providing the operator with an indication when parking regulations have been violated or other conditions; such as the identification of a stolen vehicle or a scofflaw, has been met. The operator verifies the violation conditions have been met by reviewing the data and images collected by the overview camera 240 and tire stem camera 230. The operator can reject the results or initiate other procedures such as issuing a ticket or warning, seizing the vehicle, or notifying law enforcement.

A second embodiment of the present invention, shown in FIG. 2, uses markers 110 or devices from modern parking kiosks and payment systems to identify vehicles that have paid for the privilege. The machine-readable markers 100 provide a response to the survey vehicle 200 indicating their paid status. This is used in addition to the features of the first embodiment to determine if parking regulations are being followed.

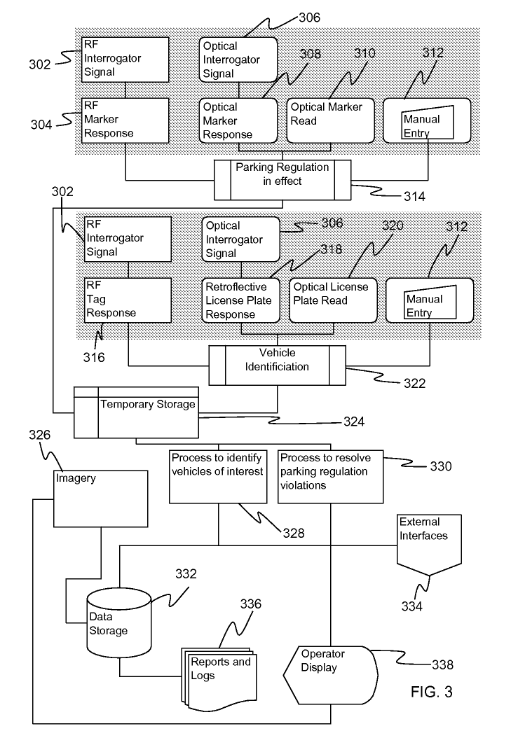

A third embodiment of the present invention, shown in FIG. 3, envisions the use of interactive machine-readable tags or devices that are updated by the survey vehicle used by parking system management. The interactive tags or devices are used to convey additional information to the survey vehicle's processor to be used in addition to the features of the first embodiment to determine if parking regulations are being followed. The process is comprised of a means for reading the vehicle information. An RF interrogator signal 302 may be sent from the marker reader 210 and an RF marker response 304 will be returned. An optical interrogator signal 306 may also or alternatively be used to generate an optical marker response 308. An optical marker read 310 or manual entry 312 of the marker 110 will also yield the same results. These four methods relay to the officer the parking regulation in effect 314 and the information is placed into temporary storage 324. The vehicle may also be identified in four similar ways. An RF interrogator signal 302 may be sent from the plate reader 220 and an RF tag response 316 will be returned. An optical interrogator signal 306 may also be used to generate a retroflective license plate response 318. An optical license plate read 320 or manual entry 312 of the license plate number will also yield the same results. These four methods relay to the officer the vehicle identification 322 and the information is placed into temporary storage 324. With this information, the officer may then use a process to identify vehicles of interest 328 or a process to resolve parking regulations 330. Information for these processes is relayed to external interfaces 334 such as an operator display 338 so the officer may easily see the imagery 326. Any tickets written will then be sent to data storage 332 to be used in the production of reports and logs 336.

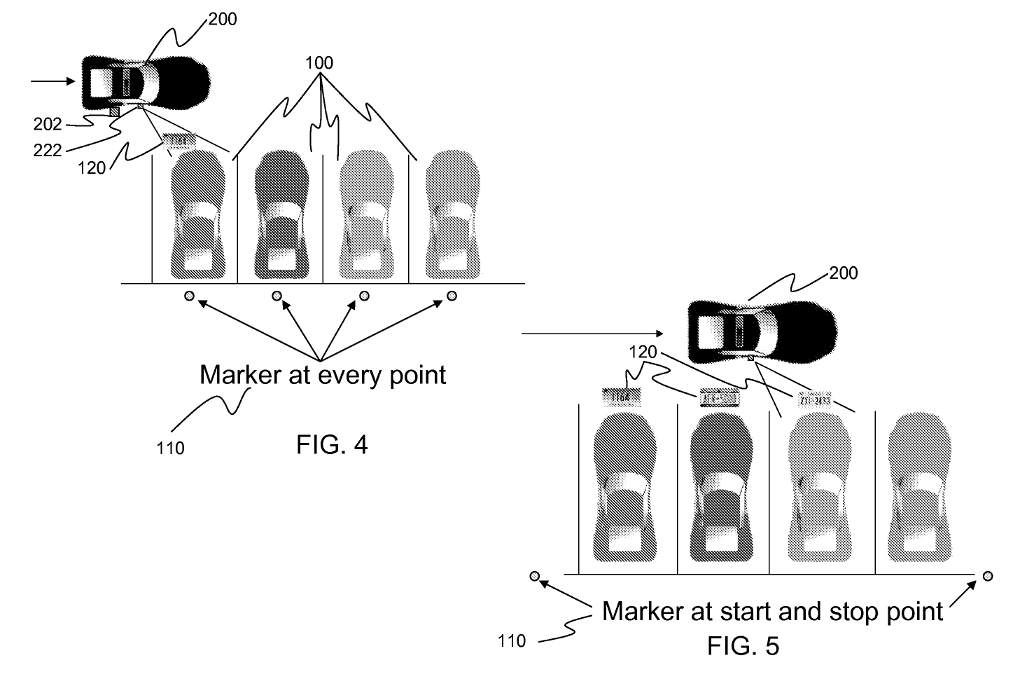

A fourth embodiment of the present invention, shown in FIG. 4 uses machine readable markers 110 emplaced on every parking spot or at the beginning and end of a series of parking spots 100. The markers 110 have the specific parking locations or space numbers encoded on or within them. As shown in FIGS. 4 and 5, the parking manager utilizes a survey vehicle 200 outfitted with a device 210 to read the markers 110, license plate reading devices 220 (e.g. a video camera 222) and a processor 250 with a display (not shown). The survey vehicle 200 approaches a parking spot or series of spots 100, and uses the marker-reading device 210 to determine the exact location of the parking space 100. The survey vehicle 200 then records from the parked vehicle(s) a license plate number from license plate(s) 120, and a response from a machine-readable marker 110. The processor on the survey vehicle stores the collected information in storage 252 or other storage means, providing the operator with an accurate database of all vehicles on the premises and their specific locations.

A fifth embodiment of the present invention, shown in FIG. 5, uses markers or devices from modern parking kiosks and payment systems to identify vehicles that have paid for the privilege. The machine-readable markers 100 provide a response to the survey vehicle 200 indicating their paid status. This is used in addition to the features of the fourth embodiment to determine if parking regulations are being followed. Additionally, such a system could check whether vehicles are improperly parked in reserved spaces.

A sixth embodiment of the present invention, not shown, surveys vehicles for research purposes; relating vehicles to emplaced property tags for effective management of parking resources, survey of parking patterns, and data collection. The relationship between vehicle license plate, a vehicle specific marker or tag, a property tag, and time is recorded for later analysis and reporting.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A method of parking surveillance comprising the steps of:
electronically reading a marker associated with a parking space;
electronically reading a license plate of a vehicle in said parking space;
associating said license plate and said parking space in a database together with time and date information.

2. A method of parking surveillance according to claim 1 wherein said step of electronically reading a marker associated with a parking space comprises optical reading of an optical marker located in or adjacent to said parking space.

3. A method of parking surveillance according to claim 1 wherein said step of electronically reading a marker associated with a parking space comprises receiving a radio signal from a radio frequency identifier located in or adjacent to said parking space.

4. A method of parking enforcement comprising the steps of:
electronically reading a marker associated with a geographic location;
determining a parking regulation based upon said marker;
electronically reading a license plate of a vehicle in a parking space in said geographic region;
electronically determining a current position of a stem of a tire of said vehicle;
identifying a matching license plate in a database of license plates, said database of license plates comprising license plate numbers, locations, times, and tire stem positions;
comparing said current position of said tire stem with a stored tire stem position associated with said matching license plate in said database;
determining whether a violation of said parking regulation has occurred.
